(19) United States
(12) Patent Application Publication
(10) Pub. No.: US 2010/0083150 A1
(43) Pub. Date: Apr. 1, 2010

(54) USER INTERFACE, DEVICE AND METHOD FOR PROVIDING A USE CASE BASED INTERFACE

(75) Inventors: Mikko Antero Nurmi, Tampere (FI); Tomi Juhani Viitala, Siivikkala (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/241,974

(22) Filed: Sep. 30, 2008

(51) Int. Cl. G06F 3/048

(52) U.S. Cl. 715/764

(57) ABSTRACT

A user interface includes a controller which is configured to receive a first and a second input identifying a first and a second object associated with each an attribute. The controller is also configured to pair the attributes to determine a resulting application according to the associated attributes and execute the resulting application.

### BACKGROUND

1. Field

The present application relates to a user interface, a device and a method for providing an improved application activation, and in particular to a user interface, a device and a method for providing a use case based application activation.

2. Brief Description of Related Developments

More and more electronic devices such as computers, mobile phones, and Personal Digital Assistants (PDAs) are being used with more and more advanced functions and features. The vast number of functions and features available makes the devices difficult for a user to use in that the user has to lean how to execute an application and for doing so how to traverse complicated menu systems to find the correct option to execute the wanted feature.

Thus it would be useful to be able to allow a user to execute an application without having to traverse the whole menu system and without having to rely on the limited number of shortcuts available. Especially as shortcuts are notoriously difficult to learn and remember.

### SUMMARY

On this background, it would be advantageous to provide a user interface, a device and a method that overcomes or at least reduces the drawbacks indicated above by providing a user interface according to a method and a computer readable medium as disclosed herein.

By realizing that a human user most often thinks in the form of use cases and not in the form of menu structures and enabling the user to input only the components of the use case instead of traversing a vast menu structure system thee user can be provided with a user interface, a method and a device that is much more efficient and intuitive to use and learn.

The aspects of the disclosed embodiments are also directed to providing a device incorporating and implementing a method or a user interface according to above.

In one embodiment the device is a mobile communications terminal, a mobile phone, a personal digital assistant (PDA), a navigation device, a camera, a computer or a laptop computer.

Further aspects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIG. 4 a, b and c are block diagrams showing associations according to the teachings herein, and

FIG. 5a, b and c are screen views of a device according to an embodiment,

FIGS. 6a and b are flow charts describing each a method according to an embodiment and

FIGS. 7a and b are screen views of a device according to an embodiment.

### DETAILED DESCRIPTION OF THE DRAWINGS

In the following detailed description, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

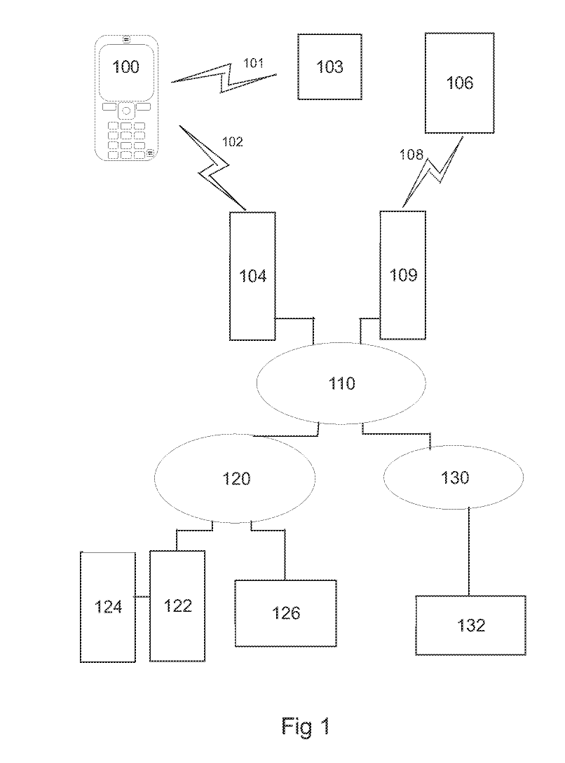

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency, RF links 102, 108 via base stations 104, 109. The mobile telecommunications network 110 may be in compliance with any commercially available mobile telecommunications standard, such as Group Spéciale Mobile, GSM, Universal Mobile Telecommunications System, UMTS, Digital Advanced Mobile Phone system, D-AMPS, The code division multiple access standards CDMA and CDMA2000, Freedom Of Mobile Access, FOMA, and Time Division-Synchronous Code Division Multiple Access, TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a World Wide Web (www) or Wireless Application Protocol (wap) server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

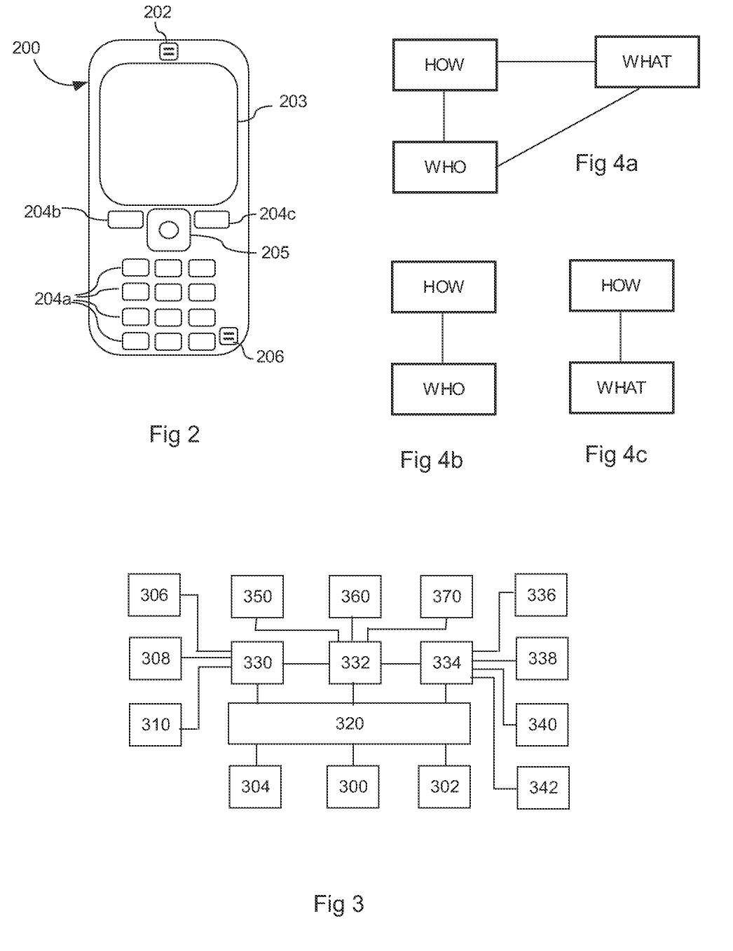

An embodiment 200 of the mobile terminal 100 is illustrated in more detail in FIG. 2. The mobile terminal 200 comprises a speaker or earphone 202, a microphone 206, a main or first display 203 being a touch display and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM) memory, Read Only memory (ROM) memory, Electrically Erasable Programmable Read-Only Memory (EEPROM) memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the first display 336/203 being a touch display, and the keypad 338/204 as well as various other Input/Output devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

It should be noted that although the device described above is a mobile phone the teachings herein can be applied equally well in other devices such as personal digital assistants, computers, laptop computers navigation devices such as hand held GPS (Global Positioning System) devices, other navigation devices such as radar monitors and cameras, both photographic and videographic cameras.

By associating items on how they are used an in what context they are used instead of in rigorous menu structures a user is offered greater freedom in selecting how to execute a task or use case. By simply selecting two objects (or more) which are paired by the controller the user can easily think in terms of use cases instead of the menu structures most commonly employed in contemporary devices. This provides a highly intuitive and easy to use and learn user interface. Furthermore there is no need for long menu traversal.

FIG. 4a is a block diagram showing how a use case or task is made up of an association of components such as content, application and contact or in other words WHAT, WHO and HOW. These metatypes are used to categorize or label objects. The association is to be understood as that a use case is based on that an action (HOW) is to be performed on an item (WHAT) for a user (WHO). Examples of such tasks are listed in table 1.

FIGS. 4b and c are two other block diagrams showing how a use case or task is made up of an association of application and either content or contact or in other words HOW and WHAT or WHO. The association is to be understood as that a task is based on that an action (HOW) is to be performed on an item (WHAT) or a user (WHO). Examples of such associations are shown in table 2.

It should be noted that the associations shown in FIGS. 4a, b and c are not one to one associations but many to many associations including the possibility of zero.

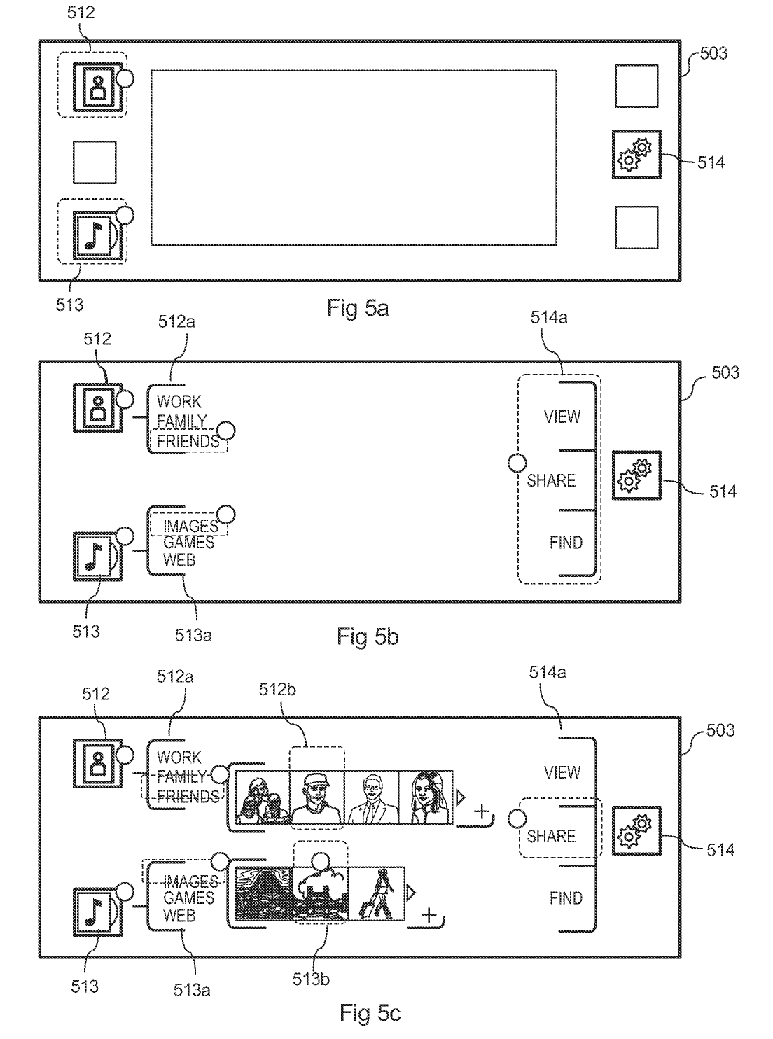

FIG. 5a is a screenshot of a display 503 of a device or a user interface according to the teachings herein. A number of icons 510 are displayed outside an active area 511. Each icon or graphical object 510 is associated with a special context. In this embodiment three icons are marked one 512 being associated contacts (WHO), one 513 being associated with content (WHAT) and one 514 being associated with application (HOW). As a user taps or touches or otherwise selects these icons as marked by the dots the options or alternatives for them are shown in FIG. 5b.

In one embodiment the selecting is made by tapping or touching an icon. In one embodiment the selecting is done simultaneously by using more than one finger or stylus and in one embodiment the selecting is done one after another, preferably within a timeout period. Should more than one alternative exist (as discussed below) the wanted alternative can in one embodiment be selected outside said time out period. In such a case a user first selects the main objects (either simultaneously or within a timeout period) and then selects the wanted alternatives. Alternatively one object is completely selected including alternatives before proceeding to select the other object(s).

FIG. 5b is another screenshot of a display 503 of a device or a user interface according to the teachings herein. In this screenshot alternatives for the three icons are shown in option or alternative lists 512a, 513a and 514a respectively. For the WHAT icon 513 the alternatives IMAGES, GAMES and WEB are displayed. For the WHO icon 512 the alternatives WORK, FAMILY and FRIENDS are displayed. And for the HOW icon 514 the alternatives VIEW, SHARE and FIND are displayed.

In one embodiment of the above user interfaces the controller is configured to display a list of attribute alternatives if an identified object is associated with more than one attribute. This enables a user to correctly choose a wanted alternative and also enables the controller to reduce the number of candidate resulting applications which improves the chances of determining the correct or wanted resulting application.

If the user touches or taps on the FRIENDS and IMAGES the actual data objects corresponding to the contacts marked as friends and the stored images as in FIG. 5c are displayed in data lists 512b and 513b respectively and the user can easily choose which contact and what image to use. The selection going from FIG. 5b to 5c does not need to be simultaneous, but the user can in one embodiment touch or tap on each of the icons in turn producing the alternatives for that selection and displaying them to the user. In that case FIG. 5c shows the result when both icons have been touched or tapped by the user. In one embodiment the user taps the two cons 513 and 512 simultaneous.

In FIG. 5c the user selects on contact and one image which are indicated by the dots. The user also selects an alternative from the options displayed for the HOW icon 514. In this example the user selects to SHARE the image with a specific contact. Thus the user has been able to select to share an image with a specific contact in three simple and easy steps directly from an idle view not having to know where the image was stored, where the contacts was stored or with which application to stat with and where the corresponding option is located in the often vast menu system of contemporary devices.

In one embodiment of the above user interfaces the first, second and third inputs are received wile said user interface being in an idle mode and without a menu structure being shown. This enables a fast and efficient input and selection of an application.

In one embodiment of the above user interfaces the controller is configured to display a list of candidate resulting applications.

In one embodiment of the above user interfaces the controller is configured to receive user input selecting a resulting application from the list of candidate resulting applications. This enables a user additional control of which application is to be executed.

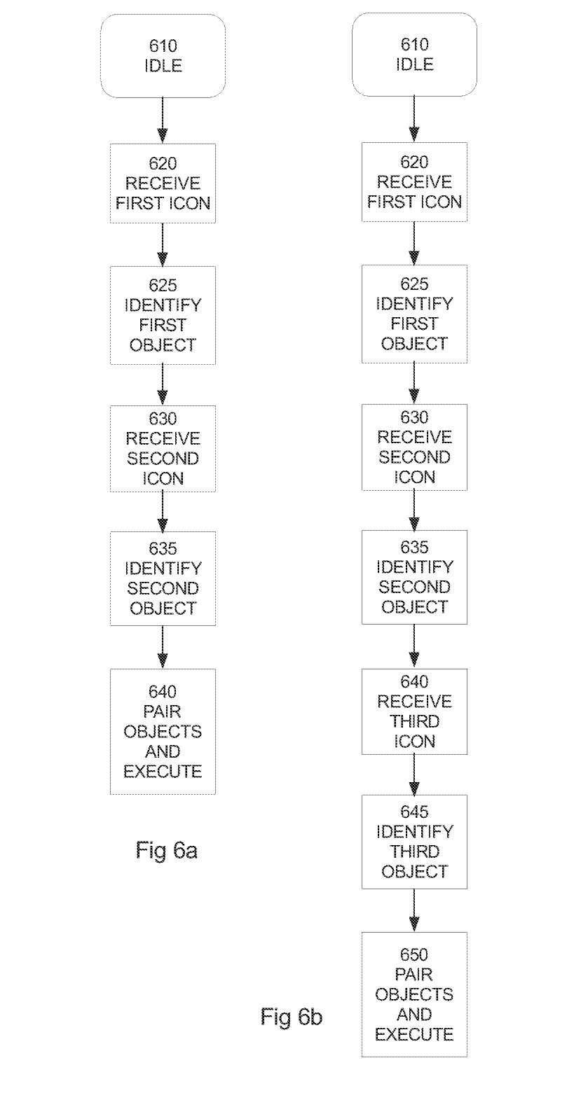

FIG. 6a shows a flowchart of a method according to the teachings herein. The method is performed by a controller which is configured to perform the steps of FIG. 6a for executing an application for identified by the press of two icons.

In an idle state 610 the controller receives user input selecting a first icon in step 620. A further user input is received selecting a second icon in step 630. It should be noted that steps 620 and 630 can be performed simultaneously or one after another. A first object associated with the first icon is identified in step 625 and a second object associated with the second icon is identified in step 635. The two objects each have a function, characteristic, data or behavior associated with them as is shown in table 2. In a step 640 the controller pairs the two objects and executes the associated function on any associated characteristic or data. The three objects each have a function, characteristic, data or behavior associated with them as is shown in table 1. In a step 650 the controller pairs the three objects and executes the associated function on any associated characteristic or data. For example, a user selects a contact icon in step 620, the contact Susan Pedersen is identified in step 625. This contact is associated with a telephone number, being a data entity. The user also selects the Call icon in step 630 and the voice call function is identified in step 635. In step 640 the function voice call is executed on the data being the telephone number to Susan Pedersen and a call is established.

In one embodiment the controller is configured to display a prompt for receiving user confirmation for executing the resulting application.

By enabling a user to combine several objects more advanced use cases can be constructed which enables a user to use a device more efficiently.

FIG. 6b shows a flowchart of a method according to the teachings herein. The method is performed by a controller which is configured to perform the steps of FIG. 6b for executing an application identified by the press of three icons.

In an idle state 610 the controller receives user input selecting a first icon in step 620. A further user input is received selecting a second icon in step 630. Yet another user input is received in step 640 identifying a third object. It should be noted that steps 620, 630 and 640 can be performed simultaneously or one after another. For example, a user selects a contact icon in step 620, the contact Susan Pedersen is identified in step 625. This contact is associated with an email address, being a data entity. The user also selects the Email icon in step 630 and the electronic mailing function is identified in step 635. Thirdly the user selects a content icon associated with a file and in step 650 the function of emailing the file to Susan is executed.

It should be noted that the function or functions associated with the selected icons determine how many more icons need to be selected or the number of icons determine the function to be executed. There are many alternatives as to how this can be implemented for various functions and applications. The tables 1 and 2 give some examples of this.

In table 2 an example of a use case only having WHAT and WHO objects is shown. The two objects are Map and a contact Susan Pedersen. The action itself or HOW attribute is implicit in the Map application and the resulting application if these two objects were to be chosen would be to display the location of Susan Pedersen on a Map, either her logged latest position (as could be relayed through a Global positioning system, GPS, device) or her registered home or office address. The Map application would in this case display a map showing for example Fredriksberg, Copenhagen and pinpointing Susan's exact address.

It should also be noted that some icons are associated with more than one attribute. One example of this is the contacts icon 512 which is both associated with a plurality of contacts and a search function. In one embodiment as described above should an object be associated with a plurality of attributes these are shown in further option lists unless the controller can make a suitable pairing. In the example above the first two object selected are the contacts and the content. No direct pairing resulting in a clear application to be executed can be achieved and thus the controller is configured to display further options as in the option or alternative lists 512a, 513a and 514a. In the example below the function SEARCH associated with the contacts icon is determined to be the correct attribute to base an application on and thus no further attributes or alternatives are shown before executing the resulting application.

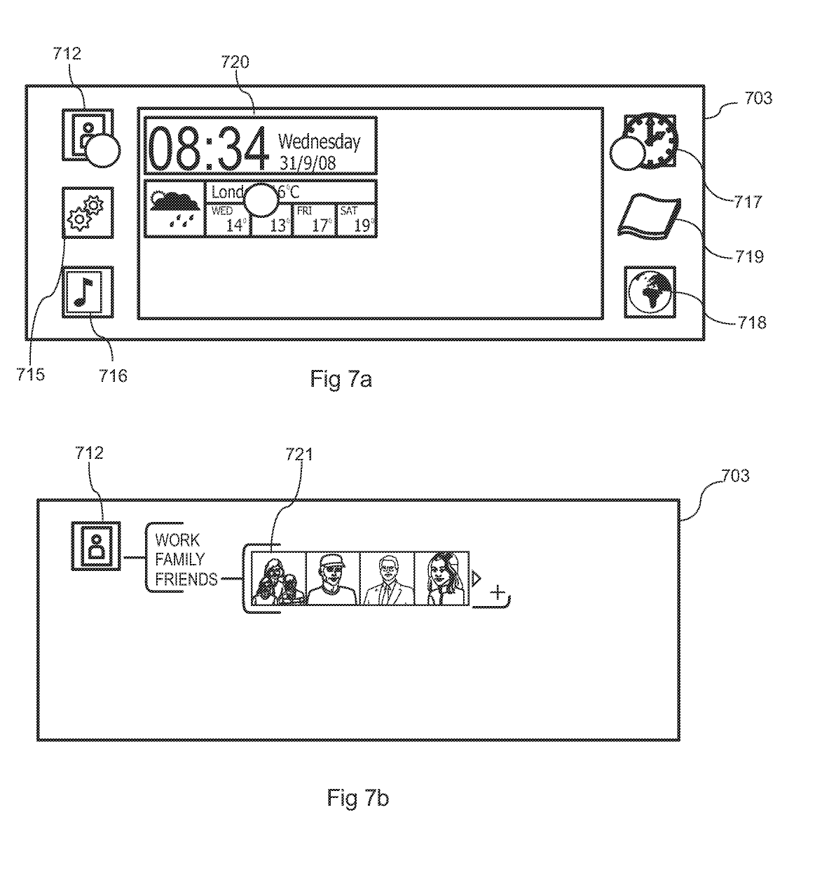

FIG. 7 shows a screen view of an example of how the teaching of this application can be used. In FIG. 7a a screen view 703 displays a widget or application 720 showing the weather ad other local information about a city, in this case London. Also shown are icons for contacts 713, settings 715 and media content 716. These icons are displayed on the left side of the display 703, but it should be understood that they can be displayed anywhere on the display 703. On the right side three icons are displayed indicating a clock function 717, an internet browser 718 and a geographical map application 719.

If a user selects the icons for the clock, which carries the attribute or data TIME OF DAY, the icon for London 720 carrying the data LONDON and the contacts icon 713 the controller will make the pairing of finding the contacts that share the attributes TIME OF DAY and LONDON or in other words the contacts that are presently detected be in London at the moment. In FIG. 7b a screen view is shown where a list 721 of the contacts presently in London is displayed. The contacts in his list can then be selected for pairing with other objects for further execution of other actions.

In this example it should be noted that the user has selected two icons that would be categorized as WHAT icons, the TIME OF DAY and LONDON and it should be clear that the identified objects may be of any of the three types and it is not required that they are one of each.

It should be noted that if several alternatives or candidates for resulting applications exist the controller is in one embodiment configured to display a list of candidate resulting applications from which a user can select which application to execute. In one embedment the user can provide further input identifying further objects which may either increase the number of candidate resulting applications or decrease the number. The displayed list of the plurality of candidate resulting applications is then updated accordingly.

In one embodiment the input of objects is received through a gesture or alternatively or in combination with multi-touch, referred to above as a simultaneous input.

As multi-touch can be difficult to achieve if the icons are spread out over the whole display the available icons are arranged along the edges of the screen in one embodiment of the teachings herein. This aids the user in reaching the wanted icons.

It should be noted that even though the teachings herein have been described with only two or three objects it should be noted that any number of objects can be selected and received by the controller as is indicated above.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers or any other device designed for providing information while maintaining low power consumption.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user can select an application, function or feature more intuitively without the need for traversing through extensive menu systems which requires that the user knows in which option list a specific feature is available. Instead the user simply selects the associated functions and data needed and they are paired to be executed accordingly by the controller

Another exemplary advantage of the teaching of the present application is that it is easy to learn and flexible to use. Also it saves memory space as the need for extensive menu structures being present in many languages is taken away and the user is able to rely more on the graphical user interface. This also has the advantage that the teachings herein can be used also by illiterate users.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the disclosed embodiments believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

TABLE 1

| TASK | HOW | WHAT | WHO |
|---|---|---|---|
| Send MMS | MMS | File: ABC.JPG | Contact: John |
| Set up | Calendar | Clock | Contact: Jack |
| appointment | | provides Time | |
| | | and Date | |
| Send email | Email | File: DEF.PPT | Contact: Jill |
| Share image | SHARE | File: GHI.GIF | Contact: Joan |
| Find image(s) | Find | Gallery Icon | Contact (or |
| of Jim | | | alternatively |
| | | | tag): Jim |
| Find messages | Find | Message icon | Contact: Jean |
| to Jean | | or inbox icon | |

TABLE 2

| TASK | HOW | WHAT | WHO |
|---|---|---|---|
| Send SMS | SMS | — | Contact: Jane |
| View video | Viewer | File: GHI.MOV | — |
| Call Contact | Call | — | Contact: Jeff |
| Locate | — | MAP | Contact: |
| Contact | | | Susan |

1. A user interface comprising a controller configured to receive a first and a second input identifying a first and a second object associated with each an attribute and to pair said attributes to determine a resulting application according to the associated attributes and execute the resulting application.

2. A user interface according to claim 1 wherein said controller is configured to receive a third input and to identify a third object being associated with a third attribute wherein the controller is configured to determine the resulting application also based on the third object and its associated attribute.

3. A user interface according to claim 1 wherein said controller is further configured to display a list of attribute alternatives if an identified object is associated with more than one attribute.

4. A user interface according to claim 1 wherein said controller is configured to receive said first and second inputs while said user interface being in an idle mode and without showing a menu structure.

5. A user interface according to claim 1 wherein said attribute is associated with data or a function.

6. A user interface according to claim 1 wherein said controller is further configured to pair said attributes to find a function that is compatible with said attributes to determine the resulting application.

7. A user interface according to claim 1 wherein said controller is further configured to display a list of candidate resulting applications.

8. A user interface according to claim 7 wherein said controller is further configured to receive user input selecting a resulting application from the list of candidate resulting applications.

9. A user interface according to claim 1 wherein each of said objects are taken from the metatype group comprising of WHAT, WHO and HOW.

10. A device incorporating and implementing a user interface according to claim 1.

11. A method for executing an application comprising receiving a first and a second input identifying a first and a second object associated with each an attribute, pairing said attributes to determine a resulting application according to the associated attributes and executing the resulting application.

12. A method according to claim 11 further comprising receiving a third input is received and identifying a third object being associated with a third attribute for which the method further comprises determining the resulting application also based on the third object and its associated attribute.

13. A method according to claim 11 further comprising displaying a list of attribute alternatives if an identified object is associated with more than one attribute.

14. A method according to claim 11 wherein said attribute is associated with data or a function.

15. A method according to claim 11 further comprising pairing said attributes to find a function that is compatible with the other attributes to determine the resulting application.

16. A method according to claim 11 further comprising displaying a list of candidate resulting applications.

17. A method according to claim 11 further comprising receiving user input selecting a resulting application from the list of candidate resulting applications.

18. A method according to claim 11 wherein each of said objects are taken from the metatype group comprising of WHAT, WHO and HOW.

19. A method according to claim 11 further comprising receiving said first and second inputs while being in an idle mode and without showing a menu structure.

20. A device incorporating and implementing a method according to claim 11.

21. A computer readable storage medium including at least computer program code for controlling a user interface comprising a display, said computer readable storage medium comprising:
software code for receiving a first and a second input identifying a first and a second object associated with each an attribute,
software code for pairing said attributes to determine a resulting application according to the associated attributes, and
software code for executing the resulting application.

22. A computer readable storage medium as in claim 21 further comprising software code for receiving a third input is received and identifying a third object being associated with a third attribute and software code for determining the resulting application also based on the third object and its associated attribute.

23. A device incorporating and implementing a computer readable storage medium according to claim 21.

24. A user interface comprising:
means for receiving a first and a second input identifying a first and a second object associated with each an attribute,
means for pairing said attributes to determine a resulting application according to the associated attributes, and
means for executing the resulting application.
